(19) United States
(12) Patent Application Publication
(10) Pub. No.: US 2011/0075637 A1
(43) Pub. Date: Mar. 31, 2011

(54) METHOD AND APPARATUS FOR PROCESSING A PSEUDO PILOT SIGNAL

(75) Inventors: Lichang WU, Shenzhen (CN); Bo Xie, Shenzhen (CN); Liqun Xiong, Shenzhen (CN)

(73) Assignee: HUAWEI TECHNOLOGIES CO., LTD., Shenzhen (CN)

(21) Appl. No.: 12/889,552

(22) Filed: Sep. 24, 2010

(30) Foreign Application Priority Data
Sep. 28, 2009 (CN) 200910093754.5

(51) Int. Cl. H04J 3/00

(52) U.S. Cl. 370/336

(57) ABSTRACT

The present invention provides a method and apparatus for processing a pseudo pilot signal. The method includes: transmitting a data service carrier signal on a first frequency in a first cell to a mobile station (MS); and transmitting a pseudo pilot signal corresponding to a voice service carrier signal on a first frequency in a second cell in at least one timeslot of the timeslots for transmitting the data service carrier signal. The apparatus includes: a first baseband processing module, configured to transmit a data service carrier signal on a first frequency in a first cell to an MS; a second baseband processing module, configured to transmit a pseudo pilot signal corresponding to a voice service carrier signal on a first frequency in a second cell; and a switching processing module, configured to switch the data service carrier signal transmitted by the first baseband processing module and the pseudo pilot signal transmitted by the second baseband processing module so that the pseudo pilot signal is transmitted in at least one timeslot of the timeslots for transmitting the data service carrier signal. With the present invention, the system complexity is decreased.

### CROSS-REFERENCE TO RELATED APPLICATION

This application claims priority to Chinese Patent Application No. 200910093754.5, filed on Sep. 28, 2009, which is hereby incorporated by reference in its entirety.

### FIELD OF THE INVENTION

The present invention relates to a communication technology, and in particular, to a method and apparatus for processing a pseudo pilot signal.

### BACKGROUND OF THE INVENTION

In the current code division multiple access (CDMA) communication system, radio spectrum resources are divided into several frequencies. Some frequencies can be provided for the CDMA 1X service, and the other frequencies can be provided for the CDMA 1X evolution-data optimized (EV-DO) service.

In the prior art, the CDMA communication system allows a same frequency in different cells to be used for the CDMA 1X service and the CDMA 1xEV-DO service. That is, the CDMA 1X service in one cell can be on a same frequency as the CDMA 1xEV-DO service in another cell. In the coverage border of the frequency, a pseudo pilot signal needs to be used to perform service switching. For example, cell A and cell B are adjacent cells in the CDMA communication system. In cell A, the F2 frequency is used to carry the CDMA 1X service. In cell B, the F2 frequency is used to carry the CDMA 1xEV-DO service. Therefore, the CDMA 1X service on the F2 frequency in cell A and the CDMA 1xEV-DO service on the F2 frequency in cell B are of the intra-frequency application. Assume that a mobile station (MS) is located in cell A and uses the CDMA 1X service on the F2 frequency in cell A. When the MS arrives at the edge of cell A and prepares to enter cell B, the MS can receive a pseudo pilot signal (on the F2 frequency) that is transmitted by a device independently configured between cell A and cell B. The MS reports the information about detection of the pseudo pilot signal to the CDMA communication system. Thus, the system knows that the MS arrives at the edge of cell A and further notifies the MS to hand over from the F2 frequency in cell A to the F1 frequency in cell B that provides the CDMA 1X service. After the MS moves to cell B, the F1 frequency may continue to carry the CDMA 1X service. A device used to transmit a pseudo pilot signal on the F2 frequency must be configured between cell A and cell B. As a result, the system complexity is increased.

### SUMMARY OF THE INVENTION

Embodiments of the present invention provide a method and apparatus for processing a pseudo pilot signal to decrease the complexity of the system in the prior art.

A method for processing a pseudo pilot signal includes:

transmitting a data service carrier signal on a first frequency in a first cell to an MS; and

transmitting a pseudo pilot signal corresponding to a voice service carrier signal on a first frequency in a second cell in at least one timeslot of the timeslots for transmitting the data service carrier signal.

An apparatus for processing a pseudo pilot signal includes:

a first baseband processing module, configured to transmit a data service carrier signal on a first frequency in a first cell to an MS;

a second baseband processing module, configured to transmit a pseudo pilot signal corresponding to a voice service carrier signal on a first frequency in a second cell; and

a switching processing module, configured to switch the data service carrier signal transmitted by the first baseband processing module and the pseudo pilot signal transmitted by the second baseband processing module so that the pseudo pilot signal is transmitted in at least one timeslot of the timeslots for transmitting the data service carrier signal.

In the preceding embodiments of the present invention, the pseudo pilot signal corresponding to the voice service carrier signal on the first frequency in the second cell is transmitted in at least one timeslot of the timeslots for transmitting the data service carrier signal on the first frequency in the first cell. That is, the pseudo pilot signal corresponding to the voice service carrier signal on the first frequency in the second cell and the data service carrier signal on the first frequency in the first cell are transmitted based on time division (TD). Thus, a device for transmitting a pseudo pilot signal on the first frequency need not be independently configured on the border between the first cell and the second cell. Therefore, the system complexity is decreased, and the cost is reduced. In addition, for an operator, the intra-frequency application of the CDMA 1xEV-DO service and the CDMA 1X service is more convenient. When the CDMA 1xEV-DO service is additionally provided on some frequency of CDMA 1X service in the low traffic area of the CDMA 1X service, the throughput of the CDMA 1xEV-DO service and the spectrum resource utilization of the CDMA 1X service can be improved.

### BRIEF DESCRIPTION OF THE DRAWINGS

To make the technical solution under the present invention clearer, the following outlines the accompanying drawings involved in the description of the embodiments of the present invention. Apparently, the accompanying drawings outlined below are exemplary only and not exhaustive, and persons of ordinary skill in the art can derive other drawings from such accompanying drawings without any creative effort.

FIG. 1 is a flowchart of a method for processing a pseudo pilot signal in an embodiment of the present invention;

FIG. 2 shows service switching between cells by adopting a pseudo pilot signal in the method for processing a pseudo pilot signal in another embodiment of the present invention;

FIG. 3 shows TD-based transmission between a data service carrier signal and a pseudo pilot signal in the method for processing a pseudo pilot signal in another embodiment of the present invention;

FIG. 4 shows a structure of an apparatus for processing a pseudo pilot signal in an embodiment of the present invention; and

FIG. 5 shows a structure of the apparatus for processing a pseudo pilot signal in another embodiment of the present invention.

### DETAILED DESCRIPTION OF THE EMBODIMENTS

The following describes the technical solution under the present invention clearly and completely with reference to the accompanying drawings. Obviously, the described embodiments are only a part of exemplary embodiments of the present invention. Based on the embodiments of the present invention, all other embodiments obtained by those skilled in the art without any creative effort are in the scope of protection defined by the following claims or their equivalents.

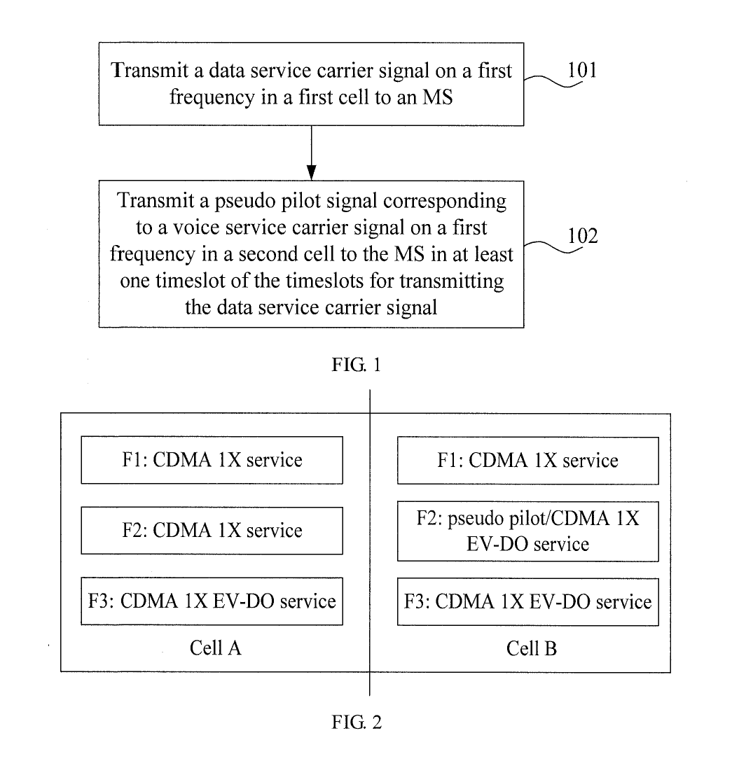

FIG. 1 is a flowchart of the method for processing a pseudo pilot signal in an embodiment of the present invention. The method includes the following steps:

Step 101: Transmit a data service carrier signal on a first frequency in a first cell to an MS.

Step 102: Transmit a pseudo pilot signal corresponding to a voice service carrier signal on the first frequency in a second cell to the MS in at least one timeslot of the timeslots for transmitting the data service carrier signal.

For example, a base transceiver station (BTS) can transmit a data service carrier signal on a first frequency in a first cell to an MS. To decrease the system complexity, the embodiment provides a feasible Huawei hybrid channel (HHC). That is, the CDMA 1X service on the first frequency in the second cell and the CDMA 1xEV-DO service on the first frequency in a first cell are used on a same frequency, and a CDMA 1xEV-DO service signal and a CDMA 1X pseudo pilot signal are transmitted based on time division. According to the TD-based transmission feature of a forward signal of the CDMA 1xEV-DO service, a CDMA 1X pseudo pilot signal is transmitted continuously in several timeslots of a CDMA 1xEV-DO service cell. The time duration of these several timeslots should meet the requirements for small impacts on the CDMA 1xEV-DO service and meet the CDMA 1X MS's requirements for the adjacent cell pilot detection.

In the embodiment of the present invention, the pseudo pilot signal corresponding to the voice service carrier signal on the first frequency in the second cell is transmitted in at least one timeslot of the timeslots for transmitting the data service carrier signal on the first frequency in the first cell. That is, the pseudo pilot signal corresponding to the voice service carrier signal on the first frequency in the second cell and the data service carrier signal on the first frequency in the first cell are transmitted based on time division. Thus, a device for transmitting a pseudo pilot signal on the first frequency need not be independently configured on the border between the first cell and the second cell. Therefore, the system complexity is decreased, and the cost is reduced. In addition, for the operator, the intra-frequency application of the CDMA 1xEV-DO service and the CDMA 1X service is more convenient. When the CDMA 1xEV-DO service is additionally provided on some frequency of CDMA 1X service in the low traffic area of the CDMA 1X service, the throughput of the CDMA 1xEV-DO service and the spectrum resource utilization of the CDMA 1X service can be improved.

FIG. 2 shows service switching between cells by adopting a pseudo pilot signal in the method for processing a pseudo pilot signal in another embodiment of the present invention. In FIG. 2, cell A and cell B are adjacent cells in the CDMA communication system. In cell A and cell B, F1, F2, and F3 correspond to a same frequency respectively. In cell A, the F1 and F2 frequencies are used to carry the CDMA 1X service, and the F3 frequency is used to carry the CDMA 1xEV-DO service. In cell B, the F1 frequency is used to carry the CDMA 1X service, and the F2 and F3 frequencies are used to carry the CDMA 1xEV-DO service. Therefore, the CDMA 1X service on the F2 frequency in cell A and the CDMA 1xEV-DO service on the F2 frequency in cell B are of the intra-frequency application.

In the former embodiment of the present invention, the first cell can be cell B in FIG. 2; the second cell can be cell A in FIG. 2; the first frequency can be F2; the data service carrier signal can be a CDMA 1xEV-DO service signal; and the voice service carrier signal can be a CDMA 1X service signal.

In the embodiment of the present invention, according to the TD-based transmission feature of a forward signal of the CDMA 1xEV-DO service, a pseudo pilot signal corresponding to a CDMA 1X service signal on the F2 frequency in cell A and a CDMA 1xEV-DO service signal on the F2 frequency in cell B can be transmitted based on time division. That is, in at least one timeslot of the timeslots for transmitting the CDMA 1xEV-DO service signal on the F2 frequency, the pseudo pilot signal on the F2 frequency can be transmitted. The timeslot of the CDMA 1xEV-DO service signal is a duration of time specified by 1.66 . . . ms. According to the requirements of the time duration, the pseudo pilot signal on the F2 frequency can occupy several timeslots of the CDMA 1xEV-DO service. Preferentially, a pseudo pilot signal on the F2 frequency can be transmitted in the timeslots of a CDMA 1xEV-DO service signal in a certain period, thus facilitating CDMA 1X MS to perform CDMA 1X pilot detection. In addition, the duration of the pseudo pilot signal on the F2 frequency can be an integral multiple of one timeslot of a CDMA 1xEV-DO service signal. Therefore, timeslot occupation of the pseudo pilot signal on the F2 frequency does not destroy data in each timeslot of the CDMA 1xEV-DO service signal, thus decreasing the impacts of the pseudo pilot signal on the CDMA 1xEV-DO service signal. In addition, when the pseudo pilot signal on the F2 frequency is transmitted, the CDMA 1xEV-DO service signal can avoid these timeslots occupied by the pseudo pilot signal actively by timeslot scheduling, thus preventing the CDMA 1xEV-DO service data from being discarded. During actual implementation, assume that an MS is located in cell A and uses the CDMA 1X service on the F2 frequency in cell A. When the MS arrives at the edge of cell A and prepares to enter cell B, the MS can detect the pseudo pilot signal on the F2 frequency and report a detection event to the CDMA communication system. Thus, the system knows that the MS is at the edge of cell A and further notifies the MS to hand over from the F2 frequency to the F1 frequency in cell A. After the MS moves to cell B, the F1 frequency may continue to carry the CDMA 1X service, thus preventing call drops of the CDMA 1X service.

Specifically, TD-based transmission between the pseudo pilot signal on the F2 frequency and the CDMA 1xEV-DO service signal on the F2 frequency can be controlled by the BTS. Therefore, a device used to transmit a pseudo pilot signal on the F2 frequency need not be separately configured between cell A and cell B.

In the preceding embodiment of the present invention, the pseudo pilot signal corresponding to the voice service carrier signal on the first frequency in the second cell is transmitted in at least one timeslot of the timeslots for transmitting the data service carrier signal on the first frequency in the first cell. That is, the pseudo pilot signal corresponding to the voice service carrier signal on the first frequency in the second cell and the data service carrier signal on the first frequency in the first cell are transmitted based on time division. Thus, a device for transmitting a pseudo pilot signal on the first frequency need not be independently configured on the border between the first cell and the second cell. Therefore, the system complexity is decreased and the cost is reduced. In addition, for the operator, the intra-frequency application of the CDMA 1xEV-DO service and the CDMA 1X service is more convenient. When the CDMA 1xEV-DO service is additionally provided on some frequency of CDMA 1X service in the low traffic area of the CDMA 1X service, the throughput of the CDMA 1xEV-DO service and the spectrum resource utilization of the CDMA 1X service can be improved.

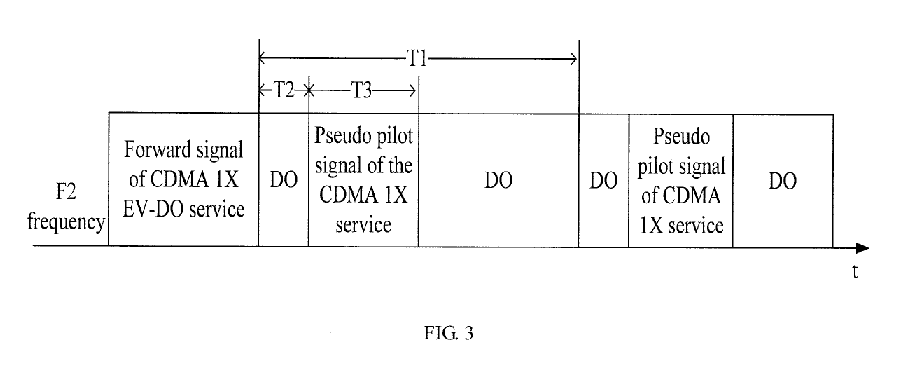

FIG. 3 shows TD-based transmission of a data service carrier signal and a pseudo pilot signal in the method for processing a pseudo pilot signal in another embodiment of the present invention. The embodiment of FIG. 3 is based on the embodiment of FIG. 1. Further, the step of transmitting a pseudo pilot signal corresponding to a voice service carrier signal on a first frequency in a second cell in at least one timeslot of the timeslots for transmitting the data service carrier signal, described in step 101 of FIG. 1 may include: in each period of time T1 for transmitting the data service carrier signal, transmitting the pseudo pilot signal in the duration T3 by taking the offset time T2 as the start point, where T1≧T2+T3. Further, the T1, T2, and T3 are the integral multiples of one timeslot.

Specifically, based on the TD-based transmission feature of a forward signal of the CDMA 1xEV-DO service, a period of transmission time T1 of the CDMA 1xEV-DO service signal can be taken as the transmission period of the pseudo pilot signal on the F2 frequency. In each period of time T1, the pseudo pilot signal on the F2 frequency can be transmitted by taking the offset time T2 as the start point. The duration of the pseudo pilot signal on the F2 frequency can be T3. T1, T2, and T3 are several integrated timeslots of the CDMA 1xEV-DO service signal. Each timeslot is a duration of time specified by 1.66 . . . ms. During actual implementation, the start time of each period T1 can be determined according to the time of the CDMA communication system and a certain rule. The several timeslots should meet the requirements for small impacts on the CDMA 1xEV-DO service and meet the CDMA 1X MS's requirements for the adjacent cell pilot detection. Preferentially, when the pseudo pilot signal on the F2 frequency is transmitted, the CDMA 1xEV-DO service signal can avoid these timeslots occupied by the pseudo pilot signal actively by timeslot scheduling, thus preventing the CDMA 1xEV-DO service data from being discarded when no transmission occurs.

The embodiment of the present invention decreases the system complexity, reduces the cost, improves the throughput of the CDMA 1xEV-DO service and the spectrum resource utilization of the CDMA 1X service, and increases the revenue of the operator, and therefore, through the design of the time relation during the TD-based transmission of the pseudo pilot signal on the first frequency and the CDMA 1xEV-DO service signal on the first frequency, the impacts of the pseudo pilot signal on the CDMA 1xEV-DO service signal are reduced.

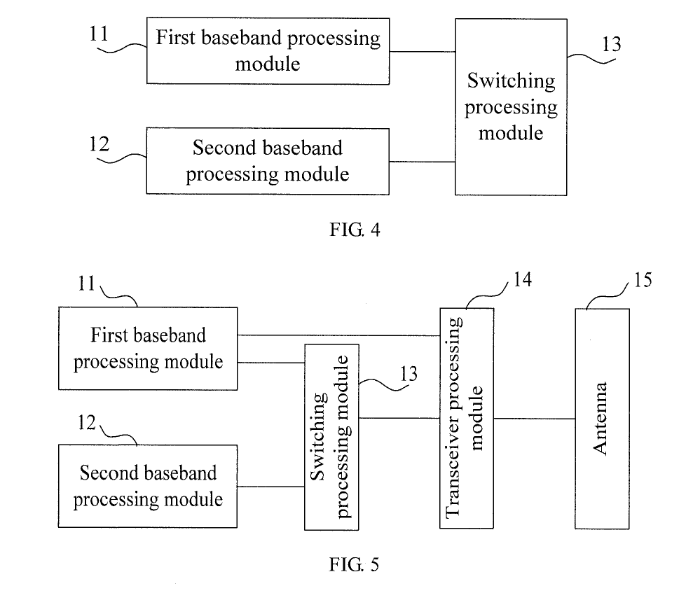

FIG. 4 shows a structure of the apparatus for processing a pseudo pilot signal in an embodiment of the present invention. As shown in FIG. 4, the apparatus may include a first baseband processing module 11, a second baseband processing module 12, and a switching processing module 13. The first baseband processing module 11 is configured to transmit a data service carrier signal on a first frequency in a first cell to an MS. The second baseband processing module 12 is configured to transmit a pseudo pilot signal corresponding to a voice service carrier signal on the first frequency in a second cell. The switching processing module 13 is configured to switch the data service carrier signal transmitted by the first baseband processing module 11 and the pseudo pilot signal transmitted by the second baseband processing module 12 so that the pseudo pilot signal is transmitted in at least one timeslot of the timeslots for transmitting the data service carrier signal.

The apparatus for processing a pseudo pilot signal in the embodiment of the present invention can be implemented by adding new hardware to the BTS or using the redundancy capability of existing hardware, thus implementing TD-based transmission of the pseudo pilot signal on the first frequency and the data service carrier signal on the first frequency. In the embodiment of the present invention, the data service carrier signal transmitted by the first baseband processing module 11 can be a CDMA 1xEV-DO service signal, and the voice service carrier signal transmitted by the second baseband processing module 12 can be a CDMA 1X pseudo pilot signal.

The implementation principle of the embodiment is the same as the implementation principle of the embodiments of the methods shown in FIG. 1 and FIG. 2 and is not described.

The apparatus for processing a pseudo pilot signal in the embodiment of the present invention transmits a pseudo pilot signal corresponding to a voice service carrier signal on a first frequency in a second cell in at least one timeslot of the timeslots for transmitting a data service carrier signal on a first frequency in a first cell. That is, the pseudo pilot signal corresponding to the voice service carrier signal on the first frequency in the second cell and the data service carrier signal on the first frequency in the first cell are transmitted based on time division. Thus, a device for transmitting a pseudo pilot signal on the first frequency need not be independently configured on the border between the first cell and the second cell. Only simple improvement needs to be performed for the BTS. Alternatively, existing hardware in the BTS is used to implement the function.

Therefore, the system complexity is decreased, and the cost is reduced. In addition, for the operator, the intra-frequency application of the CDMA 1xEV-DO service and the CDMA 1X service is more convenient. When the CDMA 1xEV-DO service is additionally provided on some frequency of CDMA 1X service in the low traffic area of the CDMA 1X service, the throughput of the CDMA 1xEV-DO service and the spectrum resource utilization of the CDMA 1X service can be improved.

Further, in the embodiment of the apparatus for processing a pseudo pilot signal shown in FIG. 4, the transmitting the pseudo pilot signal in at least one timeslot of the timeslots for transmitting the data service carrier signal includes: transmitting the pseudo pilot signal in the duration T3 by taking the offset time T2 as the start point in each period of time T1 for transmitting the data service carrier signal. The T1, T2, and T3 are the integral multiples of one timeslot, and T1≧T2+T3.

Therefore, this embodiment of the present invention decreases the system complexity, reduces the cost, improves the throughput of the CDMA 1xEV-DO service and the spectrum resource utilization of the CDMA 1X service, and increases the revenue of the operator, through the design of the time relation during the TD-based transmission of a pseudo pilot signal on a first frequency and a data service carrier signal on a first frequency, and therefore, the impacts of the pseudo pilot signal on the data service carrier signal are reduced.

FIG. 5 shows a structure of the apparatus for processing a pseudo pilot signal in another embodiment of the present invention. As shown in FIG. 5, based on the apparatus for processing a pseudo pilot signal shown in FIG. 4, the apparatus of the embodiment further includes a transceiver processing module 14. The transceiver processing module 14 is configured to: convert a data service carrier signal or a pseudo pilot signal transmitted after switching processing by the switching processing module 13 into a radio frequency (RF) signal and transmit the RF signal to the MS; receive a data service carrier signal returned by the MS; and transmit the data service carrier signal returned by the MS to the first baseband processing module 11 directly or through the switching processing module 13.

Further, the apparatus of the embodiment may include an antenna 15. Through the antenna 15, a data service carrier signal and a pseudo pilot signal can be transmitted based on time division.

In the apparatus of the embodiment, the switching processing module 13 can be configured in the BTS to transmit a pseudo pilot signal on a first frequency according to the period T1, offset time T2, and duration T3. The start time of each period T1 can be determined according to the time of the CDMA communication system and a certain rule. The start time of each period T1 may or may not be aligned with the timeslot of a CDMA 1xEV-DO service signal. In rest time of the T1 period, a forward signal of the CDMA 1xEV-DO service can be transmitted. The transceiver processing module 14 outputs a reverse signal of the CDMA 1xEV-DO service to the first baseband processing module 11 directly or through the switching processing module 13.

During actual BTS deployment, the switching processing module 13, the second baseband processing module 12, the first baseband processing module 11, and the transceiver processing module 14 can be deployed on different boards or on a same board. The transceiver processing module 14 can be deployed remotely to support several data channels. In addition, the data transmission media between various modules are not limited to electricity, light, and microwave.

In the apparatus of the embodiment, the switching processing module is configured to switch the pseudo pilot signal corresponding to the voice service carrier signal on the first frequency in the second cell and the data service carrier signal on the first frequency in the first cell based on time division. Thus, a device for transmitting a pseudo pilot signal on the first frequency need not be independently configured on the border between the first cell and the second cell. Only simple improvement needs to be performed for the BTS. Alternatively, existing hardware in the BTS is used to implement the function. Therefore, this embodiment of the present invention decreases the system complexity and reduces the cost. In addition, for the operator, the intra-frequency application of the CDMA 1xEV-DO service and the CDMA 1X service is more convenient. When the CDMA 1xEV-DO service is increased in the low traffic area of the CDMA 1X service, the throughput of the CDMA 1xEV-DO service and the spectrum resource utilization of the CDMA 1X service can be improved, and the revenue of the operator can be increased.

The embodiments described above are only preferred embodiments, which are not intended to limit the scope of protection of the present invention. It is apparent that those skilled in the art can make various modifications and variations to the invention without departing from the spirit and scope of the invention. The invention is intended to cover the modifications and variations provided that they fall within the scope of protection defined by the following claims or their equivalents.

What is claimed is:

1. A method for processing a pseudo pilot signal, comprising:
transmitting a data service carrier signal on a first frequency in a first cell to a mobile station (MS); and
transmitting a pseudo pilot signal corresponding to a voice service carrier signal on the first frequency in a second cell in at least one timeslot of the timeslots for transmitting the data service carrier signal.

2. The method of claim 1, wherein the step of transmitting a pseudo pilot signal corresponding to a voice service carrier signal on the first frequency in a second cell in at least one timeslot of the timeslots for transmitting the data service carrier signal comprises:
transmitting the pseudo pilot signal in duration T3 by taking offset time T2 as a start point in each period of time T1 for transmitting the data service carrier signal, wherein T1≧T2+T3.

3. The method of claim 2, wherein the T1, T2, and T3 are integral multiples of one timeslot.

4. An apparatus for processing a pseudo pilot signal, comprising:
a first baseband processing module, configured to transmit a data service carrier signal on a first frequency in a first cell to a mobile station (MS);
a second baseband processing module, configured to transmit a pseudo pilot signal corresponding to a voice service carrier signal on the first frequency in a second cell; and
a switching processing module, configured to switch the data service carrier signal transmitted by the first baseband processing module and the pseudo pilot signal transmitted by the second baseband processing module, so that the pseudo pilot signal is transmitted in at least one timeslot of the timeslots for transmitting the data service carrier signal.

5. The apparatus of claim 4, wherein the transmitting the pseudo pilot signal in at least one timeslot of the timeslots for transmitting the data service carrier signal comprises:
transmitting the pseudo pilot signal in duration T3 by taking offset time T2 as a start point in each period of time T1 for transmitting the data service carrier signal, wherein the T1, T2, and T3 are integral multiples of one timeslot, and T1≧T2+T3.

6. The apparatus of claim 4, further comprising:
a transceiver processing module, configured to: convert a data service carrier signal or a pseudo pilot signal transmitted after switching processing by the switching processing module into a radio frequency (RF) signal and transmit the RF signal to the MS; receive a data service carrier signal returned by the MS; and transmit the data service carrier signal returned by the MS to the first baseband processing module directly or through the switching processing module.

7. The apparatus of claim 5, further comprising:
a transceiver processing module, configured to: convert a data service carrier signal or a pseudo pilot signal transmitted after switching processing by the switching processing module into a radio frequency (RF) signal and transmit the RF signal to the MS; receive a data service carrier signal returned by the MS; and transmit the data service carrier signal returned by the MS to the first baseband processing module directly or through the switching processing module.
